(19) United States
(12) Patent Application Publication
(10) Pub. No.: US 2019/0164232 A1
(43) Pub. Date: May 30, 2019

(54) AUTOMATED SKILL RECOMMENDATION IN SOCIAL NEWORKS

(71) Applicant: INTERNATIONAL BUSINESS MACHINES CORPORATION, ARMONK, NY (US)

(72) Inventors: Lisa Seacat DeLuca, San Francisco, CA (US); Stefan Van Der Stockt, Johannesburg (ZA)

(21) Appl. No.: 15/826,798

(22) Filed: Nov. 30, 2017

(51) Int. Cl. G06Q 50/00; G06F 17/30

(52) U.S. Cl. CPC G06Q 50/01; G06F 17/30684; G06F 17/30867

(57) ABSTRACT

Utilizing a computing device to provide professional skill recommendations for use in connection with a professional social network. A computing device receives an authorization for a service to monitor internet usage by a user. Determinations are made by the computing device of professional social networks the user is a member of, and a profession of the user. The service monitors search terms entered into websites and search engines by the user. The search terms are analyzed by the service executing on the computing device to determine search terms relevant to the profession of the user. A professional skill demonstrated by the search terms relevant to the profession of the user is determined. The service executing on the computing device generates professional skill recommendations for use with the professional social network based upon the professional skill demonstrated by the search terms relevant to the profession of the user.

### BACKGROUND

The present invention relates generally to the field of social networks, and more particularly to automated skill recommendation in professional social networks.

### BRIEF SUMMARY

Embodiments of the present invention disclose a method, system, and computer program product for utilizing a computing device to provide professional skill recommendations for use in connection with a professional social network. An authorization is received from a user for a service executing on a computing device to monitor internet usage by the user. A determination is made of one or more professional social networks the user is a member of. The computing device determines a profession of the user. The service monitors one or more search terms entered by the user into websites and search engines. The service executing on the computing device analyzes the one or more search terms to determine search terms relevant to the profession of the user. A professional skill demonstrated by the search terms relevant to the profession of the user is determined. The service executing on the computing device generates one or more professional skill recommendations for use with the professional social network based upon the professional skill demonstrated by the search terms relevant to the profession of the user.

### BRIEF DESCRIPTION OF THE DRAWINGS

FIG. 1 is a functional block diagram illustrating an environment for automated professional skill recommendation in social networks, in accordance with an embodiment of the present invention.

FIG. 2 represents a web browser utilized to provide user access to a website monitored for internet usage in providing professional skill recommendations, in an embodiment of the invention.

FIGS. 3A and 3B are a flowchart depicting operational steps that a hardware component of a hardware appliance may execute, in accordance with an embodiment of the invention.

FIG. 4 depicts a block diagram of components of social network user computer, professional social network, professional skill recommendation service, website, and search engine of FIG. 1, in accordance with an embodiment of the present invention.

FIG. 5 depicts a cloud computing environment, in accordance with an embodiment of the present invention.

FIG. 6 depicts abstraction model layers, in accordance with an embodiment of the present invention.

### DETAILED DESCRIPTION

Professional social networks such as IBM Connections™, LinkedIn®, and any of a variety of others are increasingly used by individuals of all professions in professional networking. Frequently, professional social networks offer users the opportunity to list professional skills, while relying upon other users to endorse the skills without any means of analyzing the validity of endorsements for skills or providing any level of scoring for how experienced the user is truly with the professional skills. Presented is a method, system, and computer program product to provide professional skill recommendations for use in connection with a social network and, in various embodiments, to suggest an expertise score for the one or more professional skill recommendations.

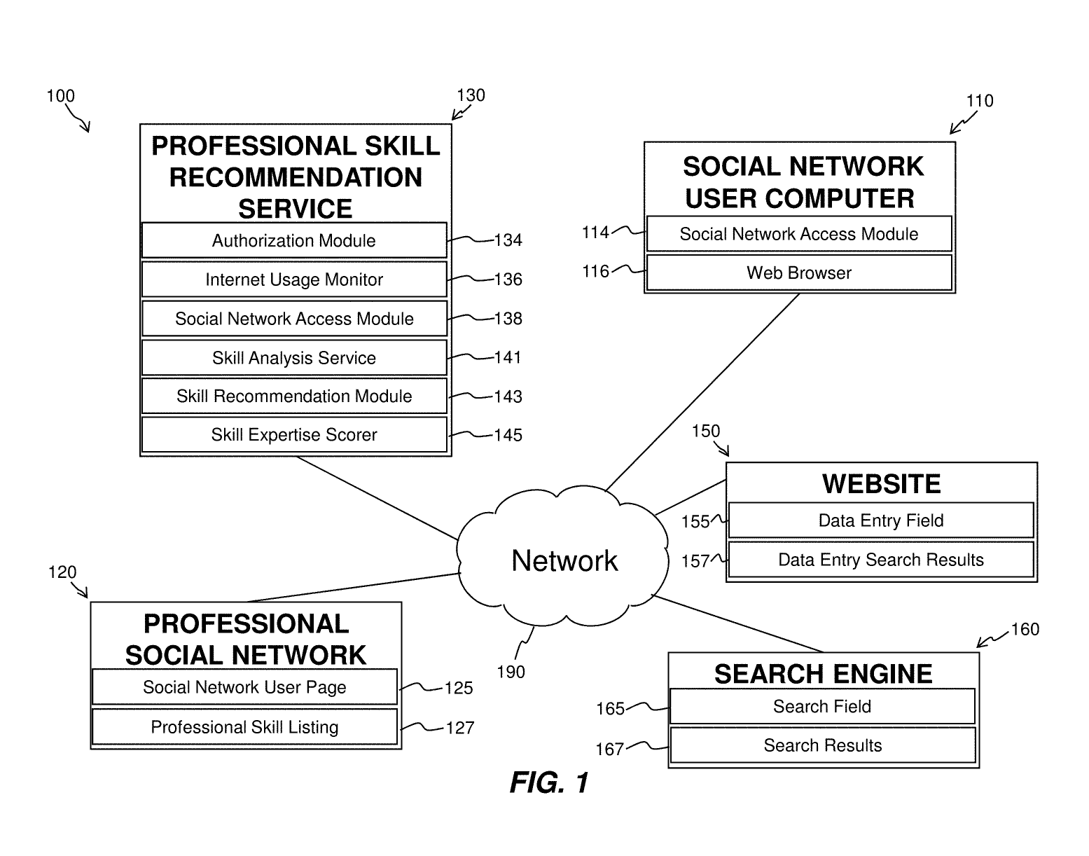

FIG. 1 is a functional block diagram illustrating an environment 100 for automated professional skill recommendation, in accordance with an embodiment of the invention. In an exemplary embodiment, a social network user computer 110 accesses a professional social network 120 to view and modify the user's own social network page, post articles and items of interest, view other individuals' personal or business social network page, communicate with other individuals or businesses, etc. The professional social network 120 offers user at social network user computer 110 the opportunity to post his or her own professional skills (or post professional skills on behalf of a business) on user's own page on the professional social network 120. In connection with the presently disclosed invention, to provide automated professional skill recommendations, the social network user computer 110 authorizes a professional skill recommendation service 130 to monitor internet usage by the social network user computer 110, as the social network user computer 110 visits websites 150, clicks on various links, enters search terms into website 150, enters search terms in search engines 160, and clicks on relevant search results generated by search engines 160. All of social network user computer 110, professional social network 120, professional skill recommendation service 130, websites 150, and search engines 160 are connected via a network 190. In various embodiments, network 190 represents, for example, an internet, a local area network (LAN), a wide area network (WAN) such as the Internet, and includes wired, wireless, or fiber optic connections. In general, network 190 may be any combination of connections and protocols that will support communications between social network user computer 110, professional social network 120, professional skill recommendation service 130, website 150, and search engine 160, in accordance with an embodiment of the invention.

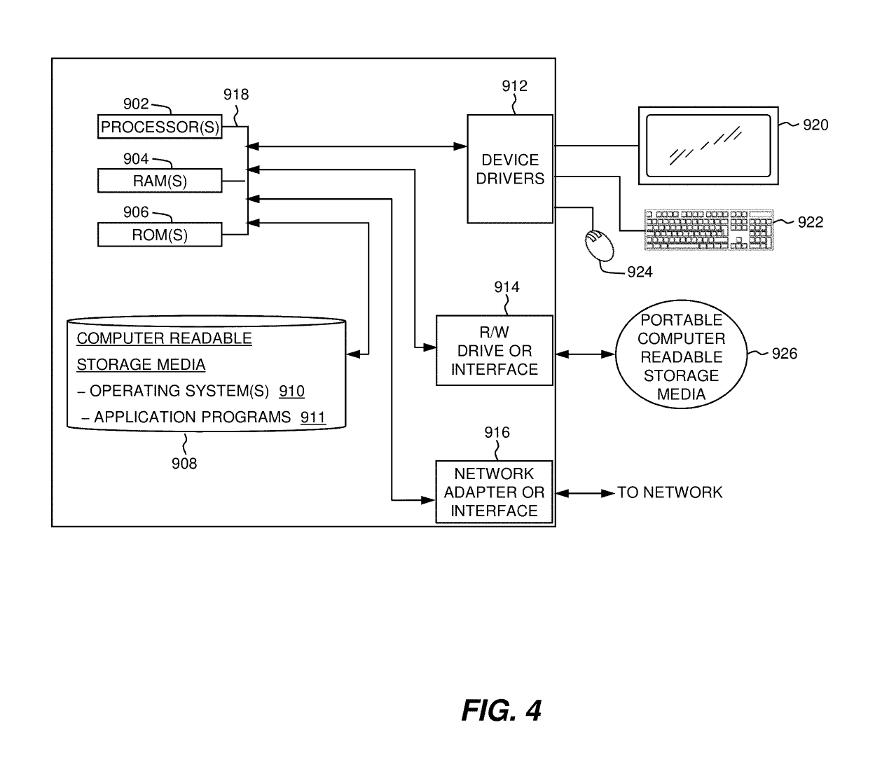

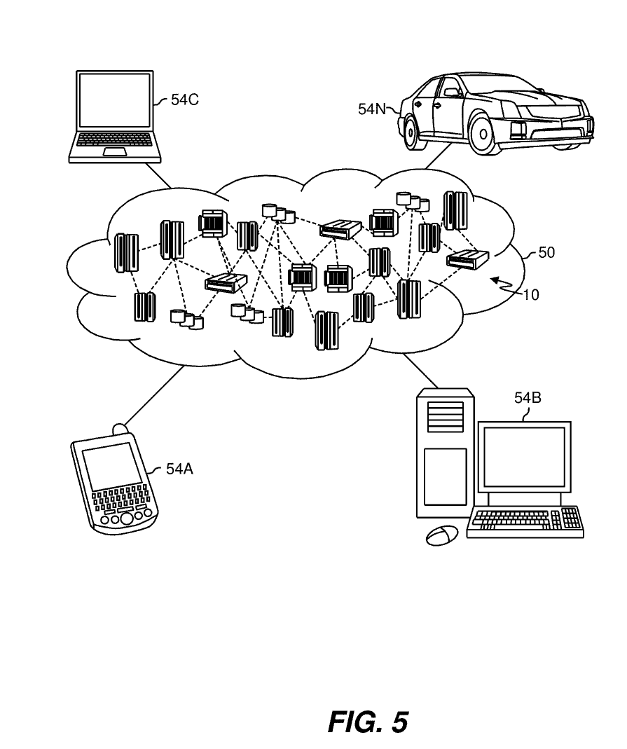

All of social network user computer 110, professional social network 120, professional skill recommendation service 130, website 150, and search engine 160 are connected via a network 190 and may be, for example, a mainframe or a mini computer, a terminal, a laptop, a tablet, a netbook personal computer, a mobile device, a desktop computer, or any other sort of computing device, in accordance with embodiments described herein. Social network user computer 110, professional social network 120, professional skill recommendation service 130, website 150, and search engine 160 may include internal and external hardware components as depicted and described further in detail with reference to FIG. 4 below. In other embodiments, each of social network user computer 110, professional social network 120, professional skill recommendation service 130, website 150, and search engine 160 may be implemented in a cloud computing environment, as described in relation to FIGS. 4 and 5, below. In a still further embodiment, some or all of social network user computer 110, professional social network 120, professional skill recommendation service 130, website 150, and search engine 160 are embodied in physically the same computing device, with all communications between various components internally.

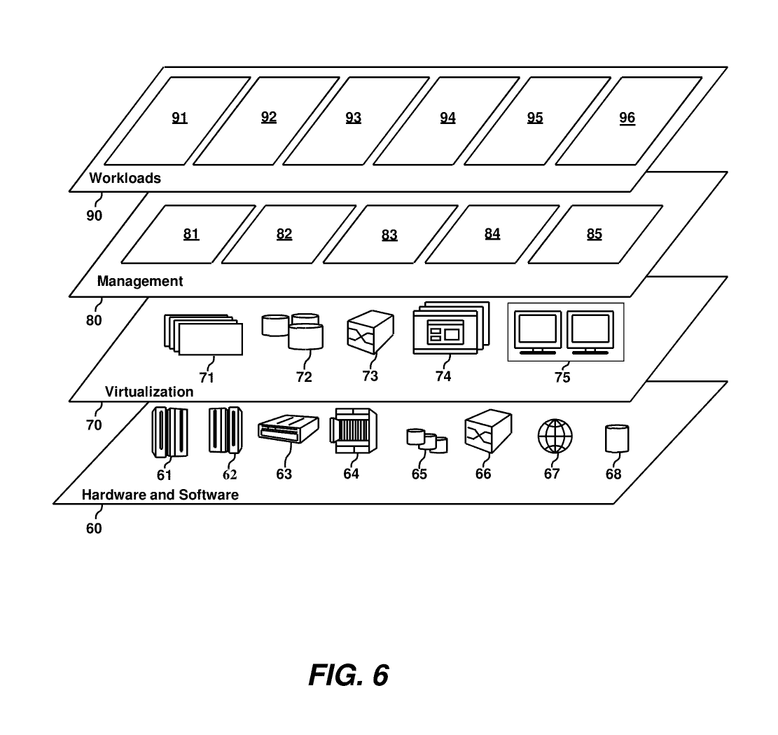

Social network user computer 110, professional social network 120, professional skill recommendation service 130, website 150, and search engine 160, in effect, represent any sort of computing device possessing sufficient processing power to execute software to generate automated professional skill recommendations. Computing devices associated with social network user computer 110, professional social network 120, professional skill recommendation service 130, website 150, and search engine 160 may, as utilized in the course of the presently disclosed invention, utilize a hosted workload 96 as displayed in connection with FIG. 6 below, and/or perform other tasks as further described herein.

In the exemplary embodiment, social network user computer 110 includes a social network access module 114, a web browser 116.

Social network access module 114 represents software for social network user computer 110 to access professional social network 120 to view and edit his or her own personal or business page on the professional social network 120, to view other personal or business pages on the professional social network 120, update professional skill listings, view other user's professional skill listings, network with other users, make new connections with other users, and provide other functionality to social network user computer 110. User at social network user computer 110 may utilize dedicated software to access professional social network 120 (such as an application, web application, or other software executing on social network user computer 110) or utilize web browser 116 to access professional social network 120.

Web browser 116 represents software executing on social network user computer 110 to access the internet via network 190. The web browser 116 provides user access to website 150 and search engine 160, providing functionality to, for example, transmit data, including search terms entered by user at social network user computer 110 for entry into website 150 and search engine 160, view data on website 160, select (or “click”) links provided by the website 150 and search engine 160 in response to search terms, etc. If dedicated software is not utilized to access and modify professional social network 120, web browser 116 is also utilized to access professional social network 120 to view personal or business pages, post on the professional social network 120, modify portions of the professional social network 120 (including the user's own personal or business page, and professional skill listings), access other professional social network 120 user pages, etc. In various embodiments of the invention, the web browser 116 is a web client such as Microsoft® Internet Explorer® or Mozilla® Firefox® using various plug-in and helper applications to access professional social network 120, website 150, and search engine 160.

In various embodiments of the invention, the web browser 116 also presents various functionality utilized specifically in connection with the presently disclosed invention. The web browser 116, upon request from professional skill recommendation service 130, presents to user at social network user computer 110 a window for the user to manually select which professional social network 120 he or she is a part of, present to user a window to manually select the profession of the user, and/or present to user a pop-up window recommending addition of a new professional skill listing, as further discussed herein.

In the exemplary embodiment, professional social network 120 includes social network user page 125 and professional skill listing 127.

Social network user page 125 represents software for maintaining a user personal page or a user's business page on the professional social network 120, available for viewing externally. The user personal page is directly associated with a user, while a business page is for a business the user owns or is responsible for maintaining a professional social network presence for. Each personal page displays relevant professional information regarding the user, which may include a full name, professional address, picture or pictures, education history, resume, job history, language skills, professional skill listings (as further discussed below) and other professional data. Each business page may include a business name, products or services offered, relevant picture or pictures, employee information, financial information regarding the business (to the extent desired by the user), jobs offered by the business, and professional skill listings for the business (as further discussed below), etc. Each personal page and business page also provides instant messaging capabilities, for professional networking purposes. Each social network user page 125 is available for viewing and editing by the social network user computer 110 (and viewing by other users for professional networking purposes) via web browser 116 or dedicated software for accessing the professional social network 120.

Professional skill listing 127 is a posting available on professional social network 120 of all professional skills on the personal page or business page of the user. The professional skills listed allow assessment of the professional abilities of the individual associated with the personal page or the business associated with the business page. For example, if the personal page is regarding a programmer, professional skill listing 127 may provide developer skills in certain computer languages, experience within certain computing environments, professional credentials with certain software applications, etc. If the personal page is regarding a business, professional skill listing 127 may provide professional skills with regard to certain products or services offered by the business.

In the presently disclosed invention, all or some of the professional skills available within professional skill listing 127 are generated automatically by the professional skill recommendation service 130, and added in a manner further discussed herein. Professional skills discussed within the professional skill listing 127 are available for viewing externally (together with the social network user page 125), via web browser 116 or dedicated software allowing access to the professional social network 120. In an embodiment of the invention, each professional skills listed within the professional skill listing 127 are displayed next to an expertise score indicating a level of expertise associated with the professional skill held by the individual or business associate with the page.

In the exemplary embodiment, professional skill recommendation service 130 includes authorization module 134, internet usage monitor 136, social network access module 138, skill analysis service 141, skill recommendation module 143, and skill expertise scorer 145.

Authorization module 134 represents software installed or executing at least in-part on professional skill recommendation service 130 to receive authorization from social network user computer 110 to monitor internet usage by the social network user computer 110 as the user at the social network user computer 110, for example, browses the internet, enters data into websites 150, views data on websites 150, utilizes search engine 160, reviews results of search engine 160 searches, accesses and modifies a user page on the professional social network 120, posts on the professional social network 120, etc. Various countries, states, or other governmental entities may require the explicit consent of social network user computer 110 to allow monitoring by the professional skill recommendation service 130 of internet usage, according to the privacy laws of each governmental entity. Such data regarding internet usage is tracked by the internet usage monitor 136, as further discussed below, after authorization is received by the authorization module 134 from the social network user computer 110.

The authorization module 134 also represents software to receive authorization from social network user computer 110 to provide professional skill recommendations by the skill recommendation module 143 for utilization with the professional social network 120, as well as authorization to generate expertise scores by the skill expertise scorer 145 for professional skills displayed in the professional social network 120, and provide other functionality, as further discussed. The authorization module 134 may also transmit to the social network user computer 110 one or more selections to be displayed in a graphic user interface within web browser 116 for the social network user computer 110 to manually select which professional social networks the user is a member of, of the professional social networks the presently disclosed invention functions with (the user at social network user computer 110 also authorizes the professional skill recommendation service 130 to monitor internet usage and provide professional skill recommendations via this selection, as expressly disclosed to the user at the social network user computer 110). The authorization module 134 may also request a graphic user interface within web browser 116 provide options for manual selection of a profession of the user at social network user computer 110, in various embodiments of the invention (or request a graphic user interface appear within dedicated software executing on social network user computer 110 to access professional social network 120 to provide such information).

Internet usage monitor 136 represents software and/or hardware installed at least in-part or executing on professional skill recommendation service 130 to monitor internet usage by the social network user computer 110, as the user associated with the social network user computer 110 accesses the internet via web browser 116. Internet usage monitor 136 monitors, for example, search terms entered by the user at social network user computer 110 into web browser 116, in real-time and which search results generated by the search engine 160 are clicked on by the user associated with social network user computer 110. Internet usage monitor 136 also monitors search terms entered into various websites 150 by the web browser 116, search results within websites 150, as well as “clicks” on various links within websites 150. Data collected by the internet usage monitor 136 is further utilized as discussed herein. After receipt of authorization by the authorization module 134 to monitor internet usage, tracking may occur by means of non-limiting example, via cookies executing in web browser 116, one or more HTTP://POST requests from web browser 116 utilizing various parameters, a session token in web browser 116, etc.

All data collection by the internet usage monitor 136 is authorized by the authorization module 134, maintained confidentially, and utilized exclusively for the purposes of the presently disclosed invention. Internet usage monitor 136 also monitors website portals the user at social network user computer 110 logs into and accesses, which may be used by the internet usage module 136 to automatically determine which professional social network(s) 120 the user is a member of.

Internet usage monitor 136, in a further embodiment of the invention, continuously monitors the search terms, search results, and “clicks” as the social network user computer 110 continues to utilize search engine 160 and website 150, for a real-time determination of which professional skills should be listed or removed on the user's professional skill listing 127 on the professional social network 120, as further discussed.

Social network access module 138 represents software installed or executing at least in-part on professional skill recommendation service 130 to access and modify user's personal page or business page on one or more professional social networks 120. Various information is available on user pages and business pages on the professional social network 120, including a profession of each user and which professional skills the social network user computer 110 has manually posted previously or automatically posted via the presently disclosed invention, for further use as discussed above and below.

Skill analysis service 141 represents software associated with professional skill recommendation service 130 to analyze data collected by the internet usage monitor 136 in generating professional skill recommendations. As the internet usage monitor 136 collects data including, for example, search terms entered into web browser 116, search results clicked-on by user at social network user computer 110, search terms entered into websites 150, search results within websites 150, and clicks on various links within websites 150, the skill analysis service 141 analyzes the data collected by internet usage monitor 136 using cognitive analysis and/or natural language processing to determine search terms, search results, and “clicks” relevant to profession of the user. For example, a search engine 160 search by social network user computer 110 for a restaurant in Seattle is not relevant to the “software engineer” profession, while a search for “how to center an image using CSS” is relevant to the “software engineer” profession. Skill analysis service 141 maintains a variable in computerized form indicating a running total of a number of search terms and “clicks” are determined by the skill analysis service 141 to be relevant to the profession of the user for further use as discussed below. If the skill analysis service 141 determines a search term, search result, or “click” is relevant to the profession of the user, the skill analysis service 141 may further determine a specific professional skill the search term, search result, or “click” demonstrates. Skill analysis service 141 maintains a variable for each professional skill, incremented by one every time the skill analysis service 141 determines a search term, search results, or click is relevant to the profession of the user.

Skill analysis service 141 utilizes natural language processing in determining a professional skill expertise level displayed by the search terms, search results, and “clicks” determined to be relevant to the profession of the user, as further discussed. Skill analysis service 141 also utilizes natural language processing determine intent of the search terms, search results, and “clicks,” also for further use as discussed.

Skill analysis service 141 is trained prior to utilization in connection with the presently disclosed invention. In training the skill analysis service 141, the skill analysis service 141 may use other pages of the professional social network 120 of individuals with similar professions to determine professional skill recommendations posted on those personal pages or business pages, for utilization in training. Alternatively, the skill analysis service 141 may be trained via cognitive analysis of keywords present in publications, papers, journal articles, paper submissions, textbooks, etc., published by individuals with professions similar to the profession of the user at social network user computer 110.

Skill analysis service 141, in the further embodiment of the invention, continuously analyzes the professional skill expertise level and intent of search terms, search results, and “clicks” collected by the internet usage module 136, as the social network user computer 110 utilizes search engine 160 and website 150 for a continuing, real-time determination of which professional skills should be listed or removed from the user's professional skill listing 127. The real-time determination continues over days, weeks, or months as the professional skill recommendation service 130 executes, showing evolution of professional skills over time and maintain only “fresh” skill listings on the professional skill listing 127 of the professional social network 120.

Skill recommendation module 143 generates professional skill recommendations for use with the professional social network 120. The professional skill recommendations generated by the skill recommendation module 143 are generated based upon the professional skill demonstrated by the search terms, search results, and/or “clicks” of the user determined by the skill analysis service 141 as relevant to the profession of the user. Skill recommendation module 143 may also base professional skill recommendations based upon expertise score, professional skill expertise level and/or intent of the search terms, search results, and/or clicks. The professional skill recommendations generated by the skill recommendation module 143 are automatically added to the professional skill listing 127 on the professional social network 120, or displayed in a pop-up appearing on the web browser 116 of the social network user computer 110 for the user at social network user computer 110 to select for addition to the user's personal page (or business page) on the professional social network 120. In an embodiment of the invention, skill recommendation module 143 may only generate professional skill recommendations if a threshold number has been reached of the variable maintained by the skill analysis service 141 for each professional skill. Equaling or exceeding the threshold number indicates the professional skill is a valid assessment of the user's skill level at the professional skill. In an alternate embodiment of the invention, the skill analysis service 141 only generates professional skill recommendations if the professional skill expertise level or expertise score for the skill determined by the skill analysis service 141 exceeds a confidence level.

Skill recommendation module 143, in the further embodiment of the invention, in response to continuous monitoring by the internet usage module 136 and continuous analysis by the skill analysis service 141 of the expertise score, professional skill level, and/or intent of the search terms, search results, and “clicks” continues to add or remove professional skills listed on the user's professional skill listing 127 in the professional social network 120 as long as professional skill service 130 keeps executing.

Skill expertise scorer 145 represents software associated with skill recommendation service 130 for generating an expertise score for the one or more professional skill recommendations, and, in alternative embodiments of the invention, generates an expertise score for all of the professional skills listed on a user's personal or business page on the professional social network 120 including those the user has added to professional skill listing himself or herself. The expertise score generated by the skill expertise scorer 145 is based upon the search terms, search results, and/or “clicks” of the user determined by the skill analysis service 141 as relevant to the profession of the user. Expertise scores generated by the skill expertise scorer 145 present an objective manner of assessing a validity of professional skills listed by the professional social network 120, as well as rating them in a quantifiable manner. After generation by the skill expertise scorer 145, the skill expertise scorer 145 transmits the expertise score to the professional social network 120 for display on the professional skill listing 127. Skill expertise scorer 145, in the further embodiment of the invention, based upon continuous analysis by the skill analysis service 141 as discussed above continuously updates the expertise score displayed in connection with each professional skill.

In the exemplary embodiment, website 150 includes data entry field 155 and data entry search results 157.

Data entry field 155 represents a field (or one or more such fields) in website 150 allowing a user at social network user computer 110 to enter search terms via keyboard 922 or computer mouse or touchpad 924 to indicate data to be searched for within the website 150. In the presently disclosed invention, search terms entered into the data entry field 155 are monitored by the internet usage monitor 136 for further use by professional skill recommendation service 130.

Data entry search results 157 represents search results provided by website 150 after entry of search terms data entry filed 155 of website 150. Search results may include data available within website 150, further pages within website 150 containing relevant data, and/or include external links to other websites containing relevant data. Search results provided by website 150 may be selected such as by “clicking” on the pages within website 150 or external links with computer mouse or touchpad 924. In the presently disclosed invention, search results or “clicks” are monitored by the internet usage monitor 136 for further use by professional skill recommendation service 130.

In the exemplary embodiment, search engine 160 includes search field 165 and search results 167.

Search field 165 represents a field in search engine 160 allowing a user at social network user computer 110 to enter search terms via keyboard 922 or computer mouse or touchpad 924 to indicate data to be searched for by the search engine 160. In the presently disclosed invention, search terms entered into the search field 165 are monitored by the internet usage monitor 136 for further use by professional skill recommendation service 130.

Search results 167 represents search results generated by search engine 160 in response to the search terms entered into the search field 165. Search results may external links to other websites containing relevant data. Search results provided by search engine 160 may be selected such as by “clicking” on the pages external links with computer mouse or touchpad 924. In the presently disclosed invention, search results or “clicks” are monitored by the internet usage monitor 136 for further use by professional skill recommendation service 130.

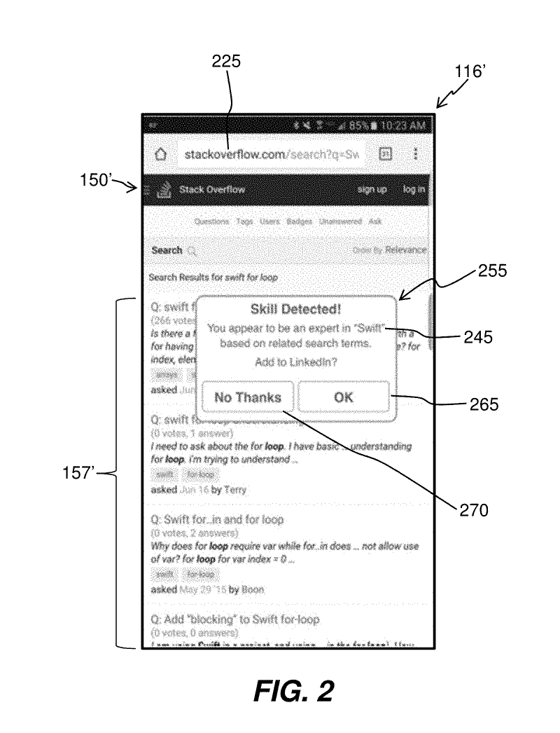

FIG. 2 represents a web browser 116′ utilized to provide user access to a website monitored for internet usage in providing professional skill recommendations, in an embodiment of the invention. The user, after entering the URL 225 into web browser 116′, is presented with website 150′. Website 150′ is available at http://stackoverflow.com, and associated with software development. The user enters search terms into a data entry field associated with website 150′ (not shown in connection with FIG. 2), and is presented with data entry search results 157′, here specifically search results 157′ from website 150′ regarding the Swift™ programming language. As discussed elsewhere herein, the internet usage monitor 136 monitors the search terms entered by the user into the website 150′ (and, in other embodiments, also monitors the data entry search results 157′, as well as other data). The skill analysis service 141 and skill recommendation module 143 utilize the search terms (and, in other embodiments, other data) to generate a professional skill recommendation 245 for the user to add to a professional social network, specifically for the programming language Swift™. The professional skill recommendation 245 appears in a pop-up window 255. The user can agree to add the professional skill 265, or decline 270.

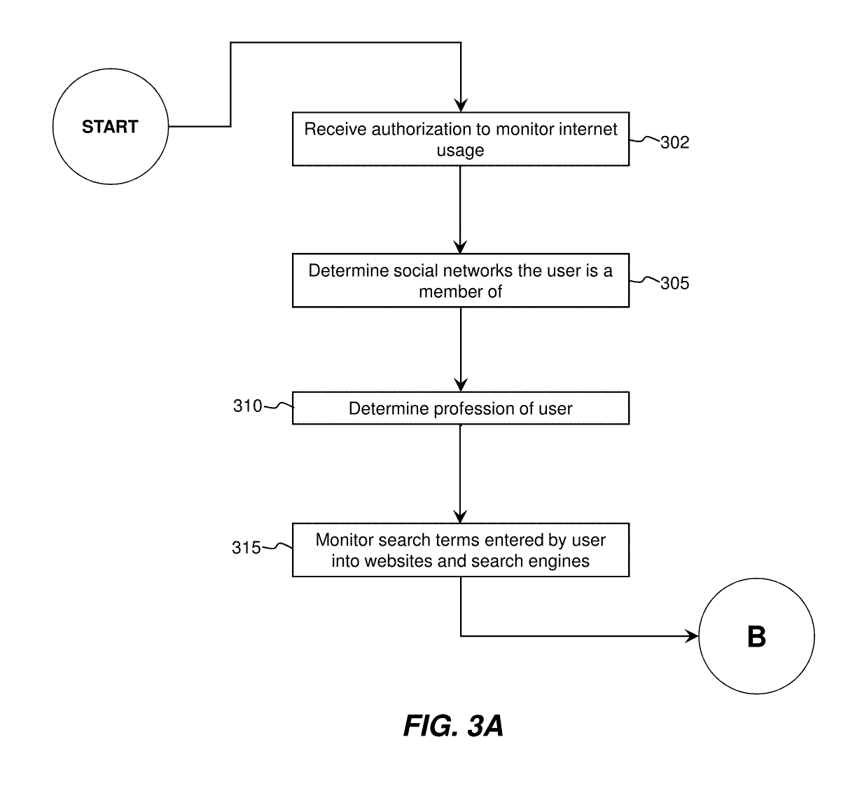

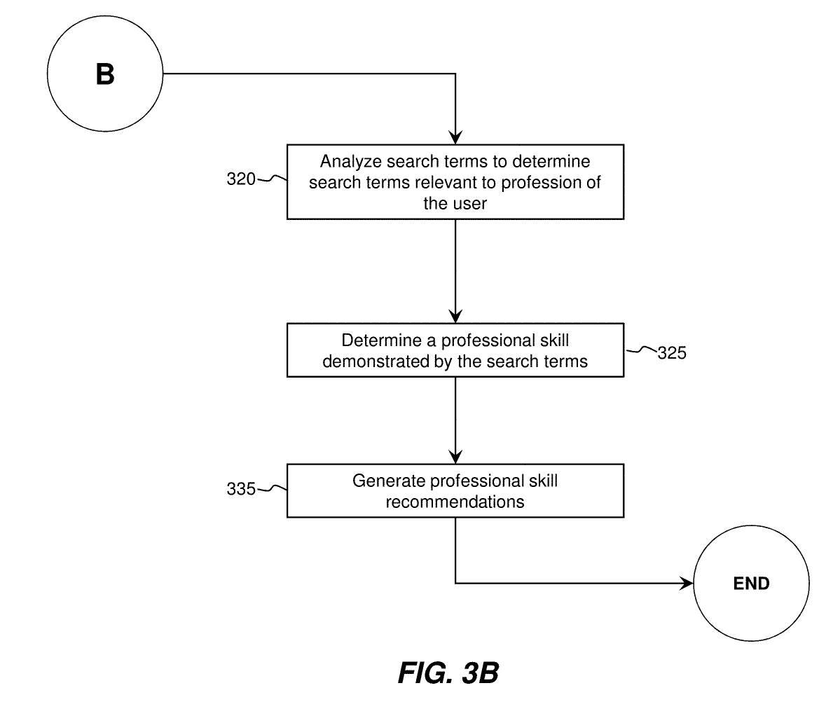

FIGS. 3A and 3B are a flowchart depicting operational steps that a hardware component, multiple hardware components, and/or a hardware appliance may execute, in accordance with an embodiment of the invention. At step 302 authorization module 134 of professional skill recommendation service 130 receives an authorization from a user at social network user computer 110 to monitor internet usage by the user. At step 305, authorization module 134 or internet usage module 136 determines one or more professional social networks 120 the user is a member of. At step 310, authorization module 134 or social network access module 138 determines a profession of the user. At step 315, the internet usage monitor 136 monitors one or more search terms entered by the user into website(s) 150 or search engine(s) 160.

At step 320, skill analysis service 141 of professional skill recommendation service 130 analyzes the one or more search terms to determine search terms relevant to the profession of the user. At step 325, skill analysis service 141 determines a professional skill demonstrated by the search terms relevant to the profession of the user. At step 335, skill recommendation module 143 generates one or more professional skill recommendations for use with the professional social network based upon the professional skill demonstrated by the search terms relevant to the profession of the user.

FIG. 4 depicts a block diagram of components of social network user computer 110, professional social network 120, professional skill recommendation service 130, website 150, and search engine 160, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Social network user computer 110, professional social network 120, professional skill recommendation service 130, website 150, and search engine 160 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the environment 100 for automated professional skill recommendation, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Social network user computer 110, professional social network 120, professional skill recommendation service 130, website 150, and search engine 160 may also include a R/W drive or interface 914 to read from and write to one or more portable computer readable storage media 926. Application programs 911 on computing device 106 may be stored on one or more of the portable computer readable storage media 926, read via the respective R/W drive or interface 914 and loaded into the respective computer readable storage media 908.

Social network user computer 110, professional social network 120, professional skill recommendation service 130, website 150, and search engine 160 may also include a network adapter or interface 916, such as a TCP/IP adapter card or wireless communication adapter (such as a 4G wireless communication adapter using OFDMA technology). Application programs 911 on first terminal 120, second terminal 140, and knowledge transfer server 160 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Social network user computer 110, professional social network 120, professional skill recommendation service 130, website 150, and search engine 160 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a method, computer program product, and/or computer system at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, computer program products, and apparatus (systems) according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of method, system, and computer program product according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the environment 100 for automated professional skill recommendation.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method of utilizing a computing device to provide professional skill recommendations for use in connection with a professional social network, the method comprising:
receiving an authorization from a user for a service executing on a computing device to monitor internet usage by the user;
determining one or more professional social networks the user is a member of;
determining by the computing device a profession of the user;
monitoring via the service one or more search terms entered by the user into websites and search engines;
analyzing, by the service executing on the computing device, the one or more search terms to determine search terms relevant to the profession of the user;
determining a professional skill demonstrated by the search terms relevant to the profession of the user; and
generating by the service executing on the computing device one or more professional skill recommendations for use with the professional social network based upon the professional skill demonstrated by the search terms relevant to the profession of the user.

2. The method of claim 1, further comprising:
generating by the service executing on the computing device utilizing natural language processing an expertise score for the one or more professional skill recommendations; and
transmitting the expertise score for the one or more professional skill recommendations for display in connection with professional skills for display on the professional social network.

3. The method of claim 2, further comprising:
continuing to monitor via the service executing on the computing device one or more search terms entered by the user into websites and search engines;
continuing to analyze via the service the one or more search terms to determine search terms relevant to the profession of the user; and
updating the expertise score displayed by the search terms relevant to the profession of the user.

4. The method of claim 3, further comprising:
removing one or more professional skill recommendations for the professional social network based upon the expertise score displayed by the search terms relevant to the profession of the user.

5. The method of claim 1, further comprising previous to generating the one or more professional skill recommendations, the computing device determines whether a threshold number has been reached by a running total of the number of search terms relevant to a particular professional skill.

6. The method of claim 1, further comprising previous to generating the one or more professional skill recommendations, the computing device determines whether the expertise score displayed by the search terms exceeds a confidence level.

7. The method of claim 1, wherein when determining which one or more professional social networks the user is a member of, the service executing on the computing device monitors one or more website portals to determine which professional social networks the user logs into or the service displays a graphic user interface for the user to select which professional social networks the user is a member of.

8. The method of claim 1, wherein the generated one or more professional skill recommendations are automatically added by the service to the professional social network for the user.

9. The method of claim 1, wherein the service displays a pop-up window to the user suggesting addition of the one or more professional skills for the professional social network.

10. A computer program product using a computing device to provide professional skill recommendations for use in connection with a professional social network, the computer program product comprising:
one or more non-transitory computer-readable storage media and program instructions stored on the one or more non-transitory computer-readable storage media, the program instructions, when executed by the computing device, cause the computing device to perform a method comprising:
receiving an authorization from a user for a service executing on a computing device to monitor internet usage by the user;
determining one or more professional social networks the user is a member of;
determining by the computing device a profession of the user;
monitoring via the service one or more search terms entered by the user into websites and search engines;
analyzing, by the service executing on the computing device, the one or more search terms to determine search terms relevant to the profession of the user;
determining a professional skill demonstrated by the search terms relevant to the profession of the user; and
generating by the service executing on the computing device one or more professional skill recommendations for use with the professional social network based upon the professional skill demonstrated by the search terms relevant to the profession of the user.

11. The computer program product of claim 10, wherein the method executed by the computing device further comprises:
generating by the service executing on the computing device utilizing natural language processing an expertise score for the one or more professional skill recommendations; and
transmitting the expertise score for the one or more professional skill recommendations for display in connection with professional skills for display on the professional social network.

12. The computer program product of claim 11, wherein the method executed by the computing device further comprises:
continuing to monitor via the service executing on the computing device one or more search terms entered by the user into websites and search engines;
continuing to analyze via the service the one or more search terms to determine search terms relevant to the profession of the user; and
updating the expertise score displayed by the search terms relevant to the profession of the user.

13. The computer program product of claim 12, wherein the method executed by the computing device further comprises:
removing one or more professional skill recommendations for the professional social network based upon the expertise score displayed by the search terms relevant to the profession of the user.

14. The computer program product of claim 10, wherein the method executed by the computing device further comprises previous to generating the one or more professional skill recommendations, the computing device determines whether a threshold number has been reached by a running total of the number of search terms relevant to a particular professional skill.

15. The computer program product of claim 10, wherein the method executed by the computing device further comprises previous to generating the one or more professional skill recommendations, the computing device determines whether the expertise score displayed by the search terms exceeds a confidence level.

16. The computer program product of claim 10, wherein when determining which one or more professional social networks the user is a member of, the service executing on the computing device monitors one or more website portals to determine which professional social networks the user logs into or the service displays a graphic user interface for the user to select which professional social networks the user is a member of.

17. The computer program product of claim 10, wherein the generated one or more professional skill recommendations are automatically added by the service to the professional social network for the user.

18. The computer program product of claim 10, wherein the service displays a pop-up window to the user suggesting addition of the one or more professional skills for the professional social network.

19. A computer system to provide professional skill recommendations for use in connection with a professional social network, the computer system comprising:
one or more computer processors;
one or more computer-readable storage media;
program instructions stored on the computer-readable storage media for execution by at least one of the one or more processors, the program instructions comprising:
program instructions to receive an authorization from a user for a service executing on a computer processor to monitor internet usage by the user;
program instructions to determine one or more professional social networks the user is a member of;
program instructions to determine by the computer processor a profession of the user;
program instructions to monitor via the service one or more search terms entered by the user into websites and search engines;
program instructions to analyze, by the service executing on the computer processor, the one or more search terms to determine search terms relevant to the profession of the user;
program instructions to determine a professional skill demonstrated by the search terms relevant to the profession of the user; and
program instructions to generate by the service executing on the computer processor one or more professional skill recommendations for use with the professional social network based upon the professional skill demonstrated by the search terms relevant to the profession of the user.

20. The computer system of claim 19, wherein the program instructions further comprise:
program instructions to generate by the service executing on the computer processor an expertise score for the one or more professional skill recommendations utilizing natural language processing; and
program instructions to transmit the expertise score for the one or more professional skill recommendations for display in connection with professional skills for display on the professional social network.
